(19) United States
(12) Patent Application Publication
(10) Pub. No.: US 2008/0168363 A1
(43) Pub. Date: Jul. 10, 2008

(54) EXTENSIBLE MECHANISM FOR CONTEXT SELECTION IN A MULTI-DIMENSIONAL DOMAIN

(75) Inventors: Randal L. Bertram, Raleigh, NC (US); Anthony W. Erwin, Rochester, MN (US); Sherry M. Pitz, Raleigh, NC (US); Andrew J. Streit, Rochester, MN (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,442

(22) Filed: Jan. 5, 2007

(51) Int. Cl. G06F 3/00

(52) U.S. Cl. 715/762

(57) ABSTRACT

The present invention relates to a method for configuring the appearance and presentation of a widget that is represented in a multi-dimensional graphical user interface, the method comprising the steps of determining available resource items that are to be displayed within a context chooser window GUI, and organizing and displaying the available resource items within the context chooser window GUI, wherein the available resource items are organized and formatted to be displayed within the context chooser window as a listing, a table, a topological map, or a tree data-structure. The method further comprises the steps of selecting at least one available resource item from the context chooser interface, displaying the selected available resource item in a context selected window GUI, wherein the selected available resource item is organized and formatted to be displayed within the context selected window as a listing, a table, a topological map, or a tree data-structure.

### BACKGROUND OF THE INVENTION

1. Field of the Invention

This invention relates to graphical user interface development technology, and particularly to a method for controlling the appearance of multiple widgets that are displayed within a graphical user interface.

2. Description of Background

Conventionally, graphical user interfaces (GUIs) comprise a set of displayed visual components that can be manipulated by a user. These displayed components can include objects such as list boxes, push buttons, check boxes, etc. In general, such components are referred to as “widgets.” Although the basic functionality of widgets is common among many GUIs, the appearance of widgets can significantly differ from one GUI to another.

Before our invention, computing system users being faced with the need to select a set of processing objects that provided a context for an additional computing operation typically were presented with a control dialog box widget, such as shown in FIG. 1. As shown in FIG. 1 the dual list chooser displays two list boxes (105, 110), wherein a system user can select and move items that are listed in the left side list box 105 to create another list at the right side list box 110. Upon selecting an item that is displayed in the left hand list box 105, the listed item thereafter forms the context for additional operations that are associated with the listed item.

This general approach to object selection is quite limiting in cases where the objects to select from cannot be easily represented in a flat list. For example, a system user may be faced with the necessity to drill-down through a navigation space of resources in order to find a resource(s) of interest. In further instances, the listing of selectable objects may most appropriately be represented by diverse visual representations (e.g., as a topological or geographic map). Therefore, there exists a need for a method to create a widget for selectable object-oriented resource items that are represented in a multi-dimensional graphical user interface.

### SUMMARY OF THE INVENTION

The shortcomings of the prior art are overcome and additional advantages are provided through the provision of a method for configuring the appearance and presentation of an object-oriented widget that is represented in a multi-dimensional graphical user interface, the method further comprising the steps of associating a unique identifier with each of a plurality of available resource items, determining at least one available resource item that is to be displayed within a context chooser window GUI, and organizing and displaying the available resource items within the context chooser window GUI, the configuration of the context chooser window being determined by the type of available resource items that are to be displayed within the context chooser window, wherein the available resource items are organized and formatted to be displayed within the context chooser window as a listing, a table, a topological map, or a tree data-structure.

The method further comprises the steps of selecting at least one available resource item from the context chooser interface, displaying the at least one selected available resource item in a context selected window GUI, wherein the selected at least one available resource item is organized and formatted to be displayed within the context selected window as a listing, a table, a topological map, or a tree data-structure, retrieving information that is associated with the at least one selected available resource item, and displaying the information that is associated with the at least one selected available resource item, wherein the selected at least one available resource item is organized and formatted to be displayed as a listing, a table, a topological map, or a tree data-structure.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a prior art toolbar dialog control box that comprises two list boxes.

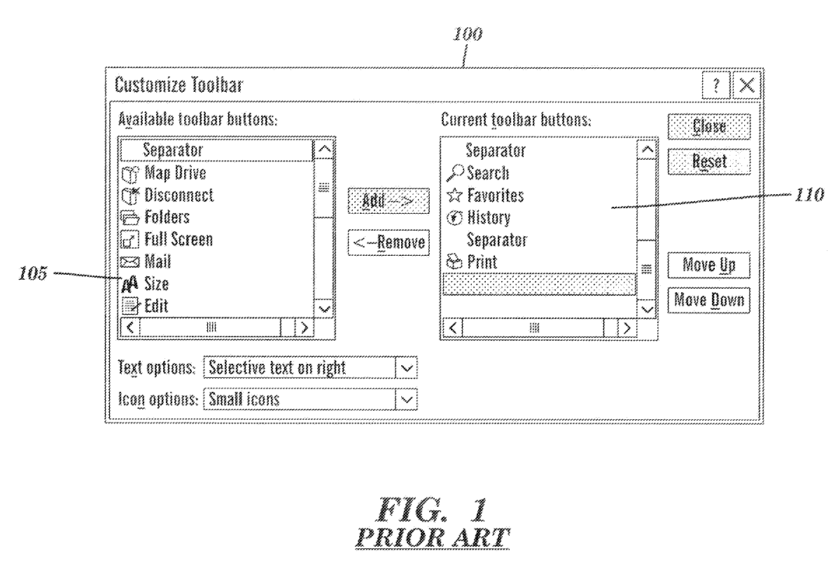

FIG. 2A illustrates one example of a context item selection widget comprising a resource navigator and a list box.

FIG. 2B illustrates one example of a context item selection widget comprising a resource navigator and a list box, wherein the context items are selected from a drill-down resource navigation list.

FIG. 3A illustrates one example of a context item selection widget comprising a topology map and a list box.

FIG. 3B illustrates one example of a context item selection widget comprising dual topology maps.

The detailed description explains the preferred embodiments of the invention, together with advantages and features, by way of example with reference to the drawings.

### DETAILED DESCRIPTION OF THE INVENTION

A widget serves as a control interface element to facilitate the interaction between a computer system user and the computing system (e.g., in the form of an interactive window). Widget toolkits comprise sets of basic building units that are utilized to create GUIs. Typically, widget toolkits are implemented as an application programming interface framework or as a library. Being created from a plurality of widgets, individual widgets comprised within a GUI are configured to perform specific predetermined tasks. Certain widgets are configured to perform the tasks of facilitating communication and interaction with the computer system user (e.g. menus, buttons, lists, check boxes, radio buttons, etc. . . . ), and other widgets are configured to perform the task of containing, or displaying the respective interactive user widgets (e.g., panels, windows, etc. . . .).

The widgets that are used to construct a GUI, and the properties of said widgets, can be modified at runtime (i.e, widgets, and content of the widgets can be added or removed from the GUI). Further, widget toolkits are responsible for detecting user initiated events (e.g., the selecting or clicking of a displayed button), whereas the action that is associated with the user initiated event is performed by an application that is associated with the widget. For example, consider the instance when a user selects a file that is comprised within a file dialog list box. The subsequent behaviors of the file dialog box widget, and the detection of the user event are controlled by the widget toolkit, while the action that is to be performed upon the file is handed off to an application to complete.

Current item selection toolbar widgets typically employ variations of dual list chooser methodologies to display available selection items to a system user. In general, this approach can prove to be quite limiting, particularly in instances where the objects from which a selection is to be made cannot easily be represented in a traditional flat listing format. For example, in order to locate a proper available resource item, a system user may require the capability to drill-down through a navigation space of resources in order to locate a desired resource. Further, the resource items in question may only be properly represented to a system user in an enhanced visual format (e.g., as a system topological map, or a geographic map). Aspects of the present invention provide sufficient solutions for these events by configuring the display resource item selection widget as a generalized item selector with enhanced item listing capabilities.

In particular, the widget mechanism as described within aspects of the present invention provides a re-usable context selection framework that comprises two interface extension points: an available item widget interface, and a selected item widget interface. The available item widget interface allows a computing system resource item context selection framework to initialize the available resource item widget interface, and thereafter retrieve any currently selected resource items. The selected resource item widget interface further enables the resource item selection framework to inform the selected resource item widget interface of currently selected resource items. As presented, the available and selected resource item widget interfaces have the capability to provide highly complex views of resource items, in addition to facilitating user interface behavior such as filtering, navigation, the setting of selection rules, and determining the format of a graphical display for a widget.

Initially, a system user is presented with a resource item context chooser widget window that has a set of available resource items that are organized in, but not limited to, a list, table, map, tree, or any other widget user interface developer determined graphical listing configuration (also known as the available items widget). Additionally, another widget is configured to display a set of resource items that the user has selected (also known as the selected items widget). Accordingly, the selected items widget can also be configured to display the selected resource items as, but not limited to, a list, table, map, tree, etc. Accordingly, a user interface developer utilizing any currently available widget programming toolkit configures the widgets that are created to organize the available and selected resource items. Further, the type of graphical display that is implemented within an available or selected resource item widget will be determined by the type of resource items that are to be displayed, in addition to the overall user interface paradigm of the widget software application.

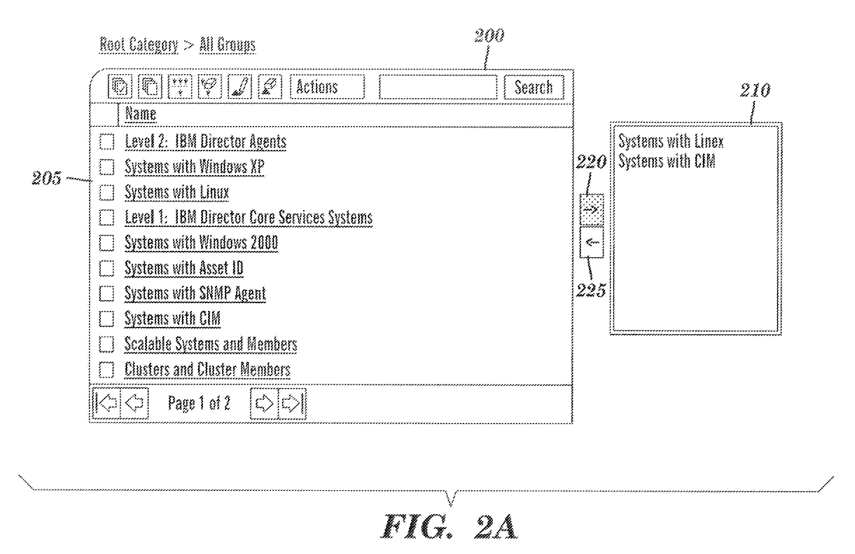

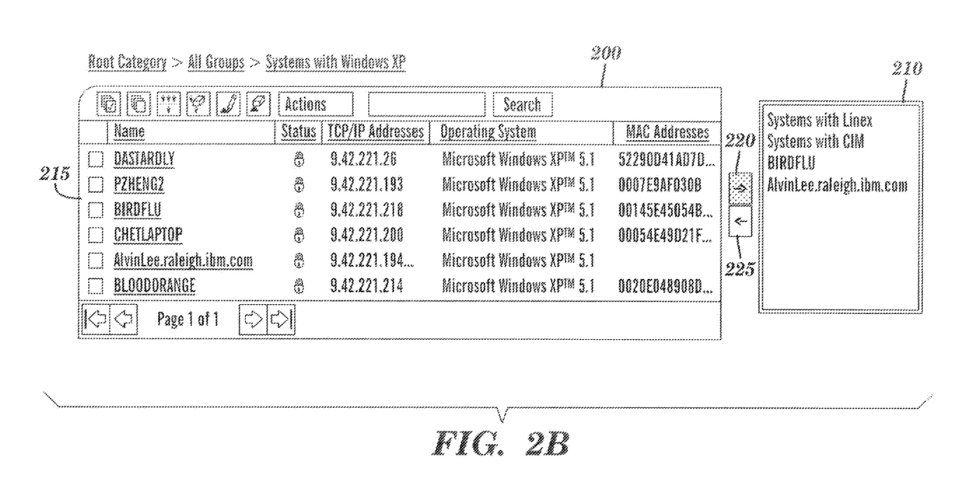

Turning now to the drawings in greater detail, it will be seen that in FIGS. 2A and 2B there is a graphical representation resource item context chooser 200 display, wherein the resource item context chooser 200 uses a resource navigator widget for the available items widget 205, and a list box for the selected items widget 210. As shown in FIG. 2A, a system user is presented with a display of all groupings of managed resource items (at 205), and has selected two groups (at 210). FIG. 2B shows the resource item context selector 200 utilizing a resource navigator widget for the available items widget 205, wherein the user has drilled-down into an item group listing (in this instance, the Systems with Windows XP listing), and accordingly is presented with a display showing the sub-item resources that are contained within the listing's group. In this instance, the user has selected two additional items from the resource sub-item listing, the items being added to the display of the selected resource item widget 210.

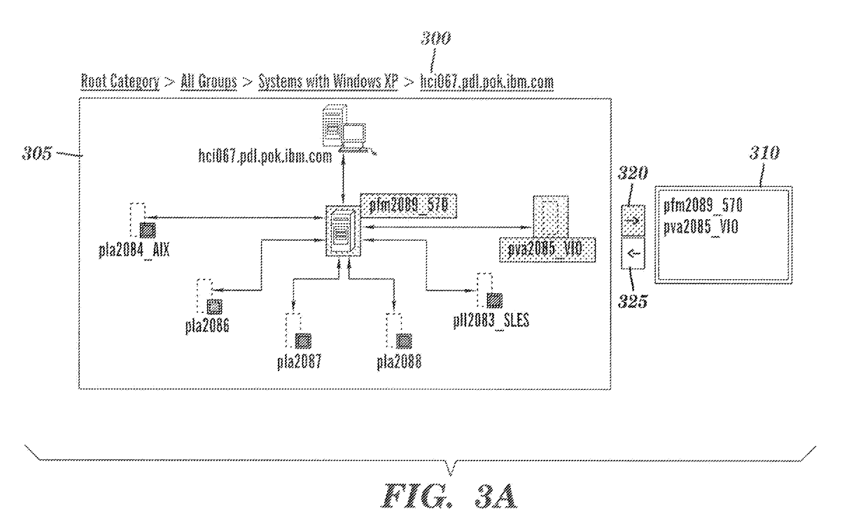

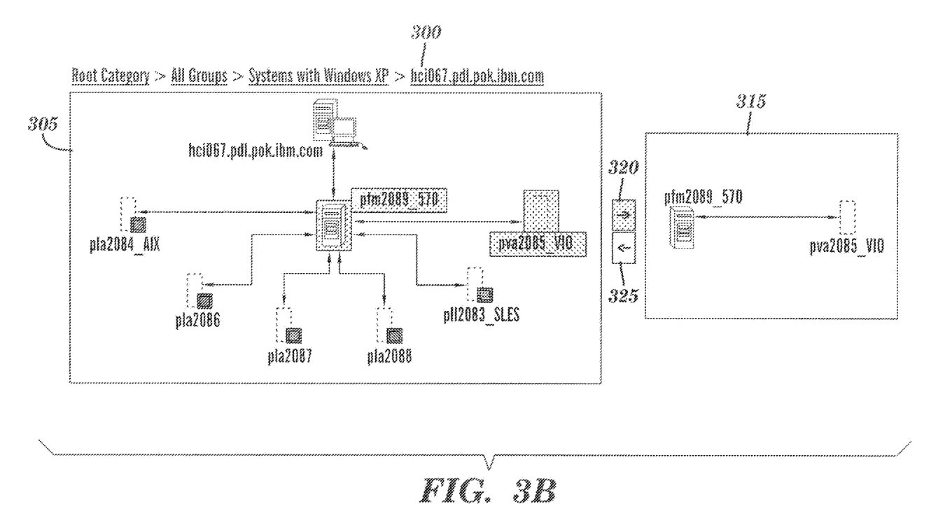

FIG. 3A shows an example of a resource item context selector 300, wherein the user has drilled down to a topological map that has been grouped within a listing of the resource navigator widget for the available items widget 205. From the topological map that is displayed at the available items widget 305 the user has selected two items, wherein the two items are added to, and displayed at the list box of the selected items widget 315. FIG. 3B is similar to FIG. 3A, but in this instance the items that are displayed in the selected items widget 315 are also rendered within a topological map.

Within aspects of the present invention, an available resource navigator widget can be initialized to a particular group of system resources in order to help guide the user in choosing resources. The suer can drill down by using bread crumbs (as shown in FIGS. 2A-3B) to continue navigating through the space to find additional resource items that they may desire to specify for a given operation.

Other examples of controls that could be used as the available items widget include, but are not limited to: a file selector for the selection of directories/files that are to be backup, wherein the file chooser is initialized to a specific directory on a file system; a web browser, wherein the web browser can be implemented to allow the user to choose several web pages to store for later offline browsing; and a geographical map, wherein cities or geographic landmarks of interest may be selected for further review.

Within aspects of the present invention the design and configuration of available and selected resource item widgets are governed by particular constraints. In particular, an available resource item widget must provide a way for a user to select one or more resource items from a displayed resource item set, that are to be added (i.e., moved or copied) to the selected resource items widget. As shown in FIGS. 2A and 2B, the table displayed within the available resource item widget provides a column of check boxes, the check boxes being used to allow the user to select one or more rows of available resource items by checking the box next to the resource item. As shown in FIGS. 3A and 3B, a user clicks on a particular icon of a resource item that is displayed within the topological map in order to select the resource item.

Further, within aspects of the present invention, selected resource item widgets must implement a method to update a listing of currently selected items. As presently described, the resource item listing can exist within the scope of the dual list chooser; however, an interface is provided for external access to a resource item list. Within aspects of the present invention, a dual resource item list chooser refreshes the resource items that are displayed within a resource item list when performing a resource item listing add operation. This functional aspect allows for a resource item list chooser to work with any widget that has been supplied for the available resource items widget, thus releasing the resource item list chooser from the responsibility of having to comprise algorithms that are specific to a particular set of widgets. The selected resource items widget must also implement this same kind of methodology so that selected resource items can be added back to the available items widget.

Within yet further aspects of the present invention, each resource item that is displayed within the available resource items widget is associated with a unique resource item identifier. For example, in the event that an item from an available items widget is added to a selected items widget, the selected items widget may only display the name of the item. Therefore, in an application where two or more resource items can have the same name, a unique resource item identifier is crucial. Within an available resource item listing, each listed resource item (see FIGS. 2A and 2B) in a table will have the resource item's unique identifier encoded in a hidden field. Upon performing a resource item selection operation, the resource item list chooser will retrieve this identifier and ensure it remains attached to the resource item that is displayed within the selected items widget.

Aspects of the present invention optionally support the narrowing of the resource item context selection process by utilizing a particular set of constraints. For example, a generic resource navigator allows a user to navigate through a set of all managed resource object items that are discovered in an IT environment. However, a particular operation may only encompass resources of the type “Host” and “Virtual Host.” Therefore, users will only be allowed to move resource object items of these types from an available items widget to a selected items widget.

As configured within aspects of the present invention, resource item context choosers (200 and 300) display at least two add and remove buttons (220, 320, 225, 325) between the available items widget (205, 305) and the selected items widget (210, 310). An add all, and a remove all button may also be displayed if desired. When the user makes a selection in the available items widget (210, 310), they then press the add button (220, 320), and thereafter, the selected resource items are displayed in the selected items widget (210, 310). Whether or not the resource items are moved or copied depends on the type of available items widget that is being utilized, or on how the user interface developer has configured the functional aspects of the widget. When the user makes a selection in the selected items widget (210, 310), they will press the remove button (225, 325), wherein thereafter, the selected resource items are no longer displayed in the selected items widget. If a move operation was performed, the resource items are now displayed in the available items widget (205, 305). Double-clicking on an item in either widget may also perform the same action as pressing the add or remove buttons (220, 320, 225, 325) if the widgets are configured to accept double-clicks. When a user has finished adding resource items to the selected resource items widget, an operation is performed to confirm the selection by the user pressing a submit button (not shown). The resource item context chooser (200, 300) provides a way for a back-end application to retrieve the user's selected resource item(s) set via a “get” function, wherein the “get” function returns a list of resource item objects that contain the pertinent data for an application.

Within yet further aspects of the present invention, a user interface developer can configure the resource item context chooser (200, 300) to allow a user to reconfigure the order of the resource items in the selected items widget. The reordering of displayed resource items can be accomplished via the use of buttons that allow for the user to move an item up or down a displayed listing, or, the user interface developer can choose not to display these buttons and simply have the chooser sort the resource list of items alphabetically, numerically, or not at all. Further, as a default setting, selected resource items widgets can be configured to initially be pre-filled with a listing of resource items, or, the selected resource items widget can initially be empty.

The capabilities of the present invention can be implemented in software, firmware, or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A method for configuring the appearance and presentation of an object-oriented widget that is represented in a multi-dimensional graphical user interface, the method further comprising the steps of:
associating a unique identifier with each of a plurality of available resource items;
determining at least one available resource item that is to be displayed within a context chooser window GUI;
organizing and displaying the available resource items within the context chooser window GUI;
selecting at least one available resource item from the context chooser interface;
displaying the at least one selected available resource item in a context selected window GUI, wherein the selected at least one available resource item is organized and formatted to be displayed within the context selected window as a listing, a table, a topological map, or a tree data-structure;
retrieving information that is associated with the at least one selected available resource item; and
displaying the information that is associated with the at least one selected available resource item, wherein the selected at least one available resource item is organized and formatted to be displayed as a listing, a table, a topological map, or a tree data-structure.

2. The method of claim 1, wherein the type of available resource items determines the configuration of the context chooser window that is to be displayed within the context chooser window.

3. The method of claim 2, wherein available resource items are organized and formatted to be displayed within the context chooser window as a listing, a table, a topological map, or a tree data-structure.

4. The method of claim 3, wherein each of the plurality of available resource items is respectfully associated with a resource object.

5. The method of claim 4, wherein a selected available resource item can be accessed in order to provide an available collection of sub-items for selection.

6. The method of claim 5, wherein the collection of sub-items can be accessed in order to provide a further available collection of sub-items for selection.

7. The method of claim 1, wherein the context chooser window GUI is configured as a web browser, the web browser being configured to allow for the selection of web pages that can be accessed for offline browsing.

8. The method of claim 1, wherein the context chooser window GUI is configured as a map of a geographic area that comprises visual indicators for geographic area cities and geographic landmarks.

9. A computer program product that includes a computer readable medium useable by a processor, the medium having stored thereon a sequence of instruction which, when executed by the processor, causes the processor to configure the appearance and presentation of an object-oriented widget that is represented in a multi-dimensional graphical user interface, wherein the computer program product executes the steps of:
associating a unique identifier with each of a plurality of available resource items;
determining at least one available resource item that is to be displayed within a context chooser window GUI;
organizing and displaying the available resource items within the context chooser window GUI;
selecting at least one available resource item from the context chooser interface;
displaying the at least one selected available resource item in a context selected window GUI, wherein the selected at least one available resource item is organized and formatted to be displayed within the context selected window as a listing, a table, a topological map, or a tree data-structure;
retrieving information that is associated with the at least one selected available resource item; and
displaying the information that is associated with the at least one selected available resource item, wherein the selected at least one available resource item is organized and formatted to be displayed as a listing, a table, a topological map, or a tree data-structure.

10. The computer program product of claim 9, wherein each of the plurality of available resource items is respectfully associated with a resource object.

11. The method of claim 10, wherein the type of available resource items determines the configuration of the context chooser window that is to be displayed within the context chooser window.

12. The method of claim 11, wherein available resource items are organized and formatted to be displayed within the context chooser window as a listing, a table, a topological map, or a tree data-structure.

13. The computer program product of claim 12, wherein a selected available resource item can be accessed in order to provide an available collection of sub-items for selection.

14. The computer program product of claim 13, wherein the collection of sub-items can be accessed in order to provide a further available collection of sub-items for selection.

15. The computer program product of claim 9, wherein the context chooser window GIU is configured as a web browser, the web browser being configured to allow for the selection web pages that can be accessed for offline browsing.

16. The computer program product of claim 9, wherein the context chooser window GUI is configured as a map of a geographic area that comprises visual indicators for geographic area cities and geographic landmarks.
